(19) United States
(12) Patent Application Publication
(10) Pub. No.: US 2011/0050800 A1
(43) Pub. Date: Mar. 3, 2011

(54) LIQUID RECEIVING APPARATUS AND LIQUID EJECTING APPARATUS

(75) Inventor: Nobuaki KAMIYAMA, Matsumoto-shi (JP)

(73) Assignee: SEIKO EPSON CORPORATION, Tokyo (JP)

(21) Appl. No.: 12/869,931

(22) Filed: Aug. 27, 2010

(30) Foreign Application Priority Data
Aug. 28, 2009 (JP) 2009-197956

(51) Int. Cl. B41J 2/165

(52) U.S. Cl. 347/31

(57) ABSTRACT

A liquid receiving apparatus includes a liquid receiving member that receives first liquid discharged from a liquid ejecting head and stores second liquid, thereby suppressing the first liquid from being precipitated. An upper portion of the liquid receiving member is opened. An absorbing member in the liquid receiving member contacts stored liquid containing the second liquid stored in the liquid receiving member and absorbs the stored liquid and the discharged first liquid. A liquid level lowering suppressing unit partitions the liquid receiving member into a first region in which an upper portion is covered by the absorbing member and second regions in which upper portions are not covered and suppresses the liquid level in the first region from lowering until the liquid level of the stored liquid in the second regions lowers to threshold height when the liquid level of the stored liquid is lowered.

Japanese Patent Application No. 2009-197956 is incorporated by reference in its entirety herein.

### BACKGROUND

1. Technical Field

The present invention relates to a liquid ejecting apparatus such as an ink jet printer and a liquid receiving apparatus provided in the liquid ejecting apparatus.

2. Related Art

In general, an ink jet printer (hereinafter, simply referred to as “printer”) is known as a liquid ejecting apparatus which ejects liquid onto a target from a liquid ejecting head. In such a printer, if a state where ink (liquid) is not ejected from a specific nozzle in a recording head (liquid ejecting head) continues for a long period of time during printing, viscosity of the ink is increased in the nozzle or a surface of ink meniscus is dried. This arises a risk that ejection failure of ink is caused. Therefore, if there is a nozzle which is not used for a long period of time during printing, maintenance called flushing in which ink droplets are discharged as waste liquid from the nozzle is performed according to a control signal which is not related to the printing.

That is to say, at the time of the flushing, the recording head is moved to a position apart from a printed region and ink is discharged to a flushing box (liquid receiving apparatus). The flushing box is arranged just under the recording head. Then, ink discharged to the flushing box in such a manner is absorbed by an absorbing member arranged in the flushing box so as to be held in the absorbing member.

If the printer is not driven for a long period of time, ink absorbed by the absorbing member at the time of the flushing is dried and precipitated due to evaporation of a solvent contained in the ink. This results in the deposition of the ink on the absorbing member. Then, as a flushing box by which precipitation due to the drying of the ink adhered to the absorbing member in the flushing box is suppressed, there has been proposed a flushing box shown in FIG. 10 in JP-A-8-150722, for example.

That is, the above flushing box includes an absorbing member which is arranged in the flushing box and is capable of absorbing ink, a washing solution supply unit which supplies a washing solution into the flushing box, and a discharge unit which discharges liquid (mixed liquid of ink and washing solution) from the flushing box. The absorbing member which has absorbed ink at the time of the flushing is washed with the washing solution supplied from the washing solution supply unit and ink is discharged together with the washing solution. Therefore, precipitation due to drying of the ink on the absorbing member can be suppressed from being generated.

Incidentally, the flushing box described in JP-A-8-150722 includes the washing solution supply unit formed of a pump or the like. Then, the washing solution for washing the absorbing member is supplied into the flushing box by the washing solution supply unit. Therefore, precipitation due to the drying of ink on the absorbing member can be suppressed from being generated. Accordingly, in the case of the flushing box described in JP-A-8-150722, there has been a problem that the configuration becomes complicated as the washing solution supply unit formed of a pump or the like is included.

### SUMMARY

An advantage of some aspects of the invention is to provide a liquid receiving apparatus and a liquid ejecting apparatus which can suppress an absorbing member arranged in a liquid receiving member to absorb liquid discharged from a liquid ejecting head from being dried with a simple configuration and keep excellent liquid receiving capacity for a long period of time.

A liquid receiving apparatus according to an aspect of the invention includes a liquid receiving member which has a bottom and is capable of receiving first liquid discharged from a liquid ejecting head and storing second liquid having a function of suppressing the first liquid from being precipitated and of which upper portion is opened, an absorbing member which is arranged in the liquid receiving member so as to be in contact with stored liquid containing the second liquid stored in the liquid receiving member and is capable of absorbing the stored liquid stored in the liquid receiving member and the first liquid discharged from the liquid ejecting head, and a liquid level lowering suppressing unit which partitions the liquid receiving member into a first region in which an upper portion is covered by the absorbing member and second regions in which upper portions are not covered by the absorbing member and suppresses the liquid level in the first region from lowering until the liquid level of the stored liquid in the second regions is lowered to height of the liquid level at a predetermined threshold value when the liquid level of the stored liquid is lowered.

With the configuration, even when the liquid level of the stored liquid in the second regions is lowered because the stored liquid in the liquid receiving member is evaporated, until the liquid level is lowered to height of the liquid level at the predetermined threshold value, the liquid level decrease suppressing unit suppresses the liquid level of the stored liquid in the first region from lowering. Accordingly, the absorbing member can keep the contact state with the stored liquid in the first region for a long period of time so as to be suppressed from drying. This makes it possible to maintain excellent liquid receiving capacity for a long period of time.

Further, in the liquid receiving apparatus according to the aspect of the invention, the liquid level lowering suppressing unit includes partition walls of which upper end edges are made to be in close contact with the absorbing member at boundaries between the first region and the second regions and which are provided so as to make the first region and the second regions be in a partitioned state, and communication portions which are provided so as to make the first region and the second regions communicate with each other at the bottom side in the liquid receiving member.

With the configuration, the absorbing member can be supported by the partition walls partitioning the liquid receiving member into the first region and the second regions in a state where the absorbing member is made to be in contact with the stored liquid. At the same time, the stored liquid in the liquid receiving member can be made to flow between the first region and the second regions through the communication portions which make the first region and the second regions communicate with each other in the liquid receiving member at the bottom side in the liquid receiving member.

Further, in the liquid receiving apparatus according to the aspect of the invention, an overflow suppressing unit which suppresses the stored liquid which is stored in the liquid receiving member from overflowing to the outside of the liquid receiving member is included in the second region.

With the configuration, even when an amount of the stored liquid in the liquid receiving member is increased as the first liquid discharged from the liquid ejecting head is received in the liquid receiving member, liquid for the increased amount can be suppressed from overflowing from the liquid receiving member.

Further, in the liquid receiving apparatus according to the aspect of the invention, the overflow suppressing unit is formed of an overflow pipe which is provided such that a flow-in port is opened to the second region in the liquid receiving member and a flow-out port is provided at a lower position with respect to the flow-in port and opened to the outside of the liquid receiving member, and the flow-in port is provided at a lower position with respect to an upper surface of the absorbing member arranged in the liquid receiving member.

With the configuration, the liquid level of the stored liquid stored in the liquid receiving member never becomes higher than the upper surface of the absorbing member. Therefore, the stored liquid can be reliably suppressed from overflowing from the liquid receiving member beyond the opening.

Further, a liquid ejecting apparatus according to another aspect of the invention includes a liquid ejecting head which ejects liquid, and the above liquid receiving apparatus which receives the liquid discharged from the liquid ejecting head as waste liquid.

With the configuration, the same effects as the aspect of the invention relating to the above liquid receiving apparatus can be obtained.

### BRIEF DESCRIPTION OF THE DRAWINGS

The invention will be described with reference to the accompanying drawings, wherein like numbers reference like elements.

FIG. 1 is a schematic front view illustrating an ink jet printer according to an embodiment of the invention.

FIG. 2A is a plane view schematically illustrating a flushing box according to the embodiment while an ink absorbing member and stored liquid are not illustrated. FIG. 2B is a cross-sectional view schematically illustrating the flushing box.

FIG. 3A is a plane view schematically illustrating a usage state of the flushing box according to the embodiment. FIG. 3B is a cross-sectional view schematically illustrating the usage state of the flushing box.

FIG. 4 is a cross-sectional view schematically illustrating a flushing box in a state where a liquid level of stored liquid which is stored in second regions is lowered.

### DESCRIPTION OF EXEMPLARY EMBODIMENTS

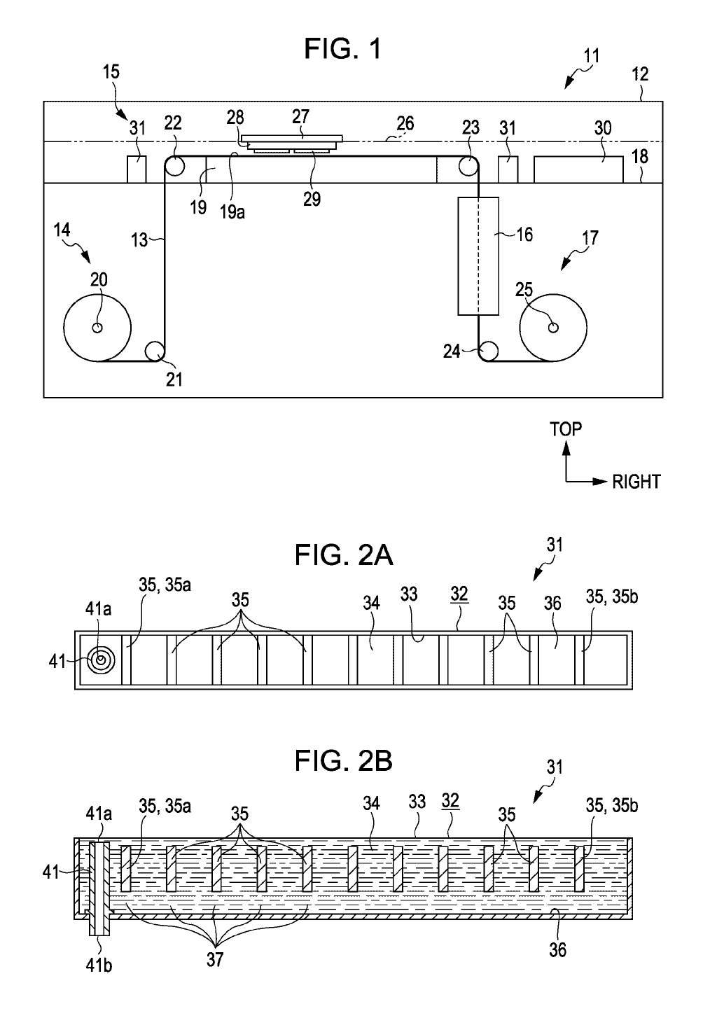

Hereinafter, an embodiment in which the invention is embodied as a lateral type ink jet printer will be described with reference to FIG. 1 to FIG. 4. It is to be noted that “depth direction”, “horizontal direction”, and “vertical direction” are indicated based on the directions shown by arrows in FIG. 1 in the description below.

As shown in FIG. 1, an ink jet printer 11 as a liquid ejecting apparatus includes a hexahedron main body case 12. In the main body case 12, a feeding portion 14, a printing chamber 15, a drying device 16 and a winding-up portion 17 are provided. The feeding portion 14 feeds a lengthy continuous sheet (target) 13. The printing chamber 15 performs printing by ejecting ink (first liquid) onto the continuous sheet 13. The continuous sheet 13 to which ink is adhered by the printing undergoes a drying processing by the drying device 16. The winding-up portion 17 winds up the continuous sheet 13 having undergone the drying processing as described.

A plate-like base board 18 is provided at a slightly upper position with respect to a center in the vertical direction in the main body case 12. The plate-like base board 18 divides an inner portion of the main body case 12 into an upper portion and a lower portion. An upper side region with respect to the base board 18 serves as a printing chamber 15. In the printing chamber 15, a rectangular plate-like platen (support member) 19 is supported on the base board 18. The feeding portion 14 is arranged in a lower side region with respect to the base board 18 and is also at the left side position, on an upstream side in the transport direction of the continuous sheet 13. Further, the drying device 16 and the winding-up portion 17 are arranged at the right side position on a downstream side.

As shown in FIG. 1, a winding shaft 20 extending in the depth direction is rotatably provided in the feeding portion 14. The continuous sheet 13 is supported on the winding shaft 20 so as to be integrally rotatable with the winding shaft 20 in a state where the continuous sheet 13 is previously wound around the winding shaft 20 in a roll shape. That is to say, the continuous sheet 13 is fed from the feeding portion 14 and transported to the downstream side in the transport direction when the winding shaft 20 is rotated. Further, a first roller 21 is provided at the right side of the feeding portion 14 so as to extend in the depth direction in parallel with the winding shaft 20. The first roller 21 converts the transport direction of the continuous sheet 13 to a vertical upward direction by winding up the continuous sheet 13 fed from the winding shaft 20 from the lower right side.

On the other hand, a second roller 22 is provided in the printing chamber 15 at the left side of the platen 19 so as to extend in the depth direction in parallel with the first roller 21 arranged on the lower side of the second roller 22. At this time, the second roller 22 is provided at a position corresponding to the first roller 21 arranged on the lower side in the vertical direction. The continuous sheet 13 of which transport direction has been converted to the vertical upward direction by the first roller 21 is wound over the second roller 22 from the lower left side. Therefore, the transport direction of the continuous sheet 13 is converted to the horizontal right direction and the continuous sheet 13 is made to be in slide contact with a support surface 19a which is an upper surface of the platen 19.

Further, a third roller 23 is provided in the printing chamber 15 at the right side of the platen 19 so as to extend in the depth direction in parallel with the second roller 22. At this time, the third roller 23 is provided so as to be opposed to the second roller 22 arranged at the left side with respect to the platen 19 in the horizontal direction. Note that arrangement positions of the second roller 22 and the third roller 23 are adjusted such that tops of the peripheral surfaces of the second roller 22 and the third roller 23 are the same in height as the support surface 19a which is an upper surface of the platen 19.

Therefore, the continuous sheet 13 of which transport direction has been converted to the horizontal right direction by the second roller 22 at the left side in the printing chamber 15 is transported to the right side on the downstream side. At this time, the continuous sheet 13 is transported while being in slide contact with the support surface 19a which is an upper surface of the platen 19. Thereafter, the continuous sheet 13 is wound over the third roller 23 from the upper right side so that the transport direction thereof is converted to the vertical downward direction. Therefore, the continuous sheet 13 is transported toward the drying device 16 arranged on the lower side with respect to the base board 18. Then, the continuous sheet 13 subjected to the drying processing by passing through the drying device 16 is transported in the vertical downward direction further.

A fourth roller 24 is provided at the lower side of the drying device 16 so as to extend in the depth direction. The transport direction of the continuous sheet 13 is converted to the horizontal right direction by winding the continuous sheet 13 which has passed through the drying device 16 and transported in the vertical downward direction over the fourth roller 24 from the upper left side. The winding-up portion 17 is arranged at the right side of the fourth roller 24. A winding-up shaft 25 extending in the depth direction in parallel with the fourth roller 24 is provided in the winding-up portion 17 so as to rotate with driving force of a transport motor (not shown). An end of the continuous sheet 13 is wound around the winding-up shaft 25 at the downstream side end in the transport direction.

Guide rails 26 (shown by two-dot-dash lines in FIG. 1) extending in the horizontal direction are provided in front of and behind the platen 19 so as to form a pair in the printing chamber 15. Upper surfaces of the guide rails 26 are higher than the support surface 19a which is an upper surface of the platen 19. A rectangular-shaped carriage 27 is supported on the upper surfaces of the both guide rails 26 so as to be reciprocatable in the horizontal direction along the both guide rails 26 based on driving of a driving mechanism (not shown). A recording head (liquid ejecting head) 29 is supported on a lower surface side of the carriage 27 through the support plate 28.

A specified range within the left end to the right end on the platen 19 is set as a printing region in the printing chamber 15, and the continuous sheet 13 is intermittently transported in units corresponding to this printing region. Ink is ejected from the recording head 29 onto the continuous sheet 13 while the carriage 27 makes the reciprocative movement so that printing is performed on the continuous sheet 13. At this time, the continuous sheet 13 is in a state where the continuous sheet 13 is stopped on the platen 19 by the intermittent transport on the printing region. Further, a maintenance mechanism 30 which performs maintenance of the recording head 29 while printing is not performed is provided on a non-printing region on the right side of the third roller 23 in the printing chamber 15. Further, a left and right pair of flushing boxes (liquid receiving apparatuses) 31 for receiving discharged ink at the time of so-called flushing are provided on the left and right sides of the platen 19. In the flushing, ink is discharged as waste ink (waste liquid) from nozzle openings (not shown) of the recording head 29 based on a control signal which is not related to printing in printing process.

Next, a configuration of each flushing box 31 is described in detail with reference to FIG. 2A to FIG. 4. It is to be noted that the flushing box 31 located at the left side and the flushing box 31 located at the right side have the same configuration.

As shown in FIGS. 2A and 2B, each flushing box 31 has a box body 32 as a liquid receiving member having a box shape with a bottom. The box body 32 extends lengthwise along the depth direction in parallel with the nozzle opening row (not shown) of the recording head 29 and an upper end of the box body 32 is opened. The box body 32 can receive ink discharged from the recording head 29 that has moved to the upper position of the box body 32 at the time of flushing through an opening 33 which is the upper end. An inner portion of the box body 32 serves as a storage portion 34 which can store water as second liquid having a function of suppressing ink from being precipitated.

In the box body 32, a plurality of (eleven ribs in the embodiment) longitudinal ribs 35 are provided between both side walls along a longitudinal direction of the box body 32 at predetermined intervals in the longitudinal direction of the box body 32. These longitudinal ribs 35 divide an inner portion of the storage portion 34 into a plurality of regions in a planar view. The length of each longitudinal rib 35 in the lengthwise direction is shorter than the length of the storage portion 34 in the lengthwise direction (that is, the depth of the storage portion 34) in the box body 32.

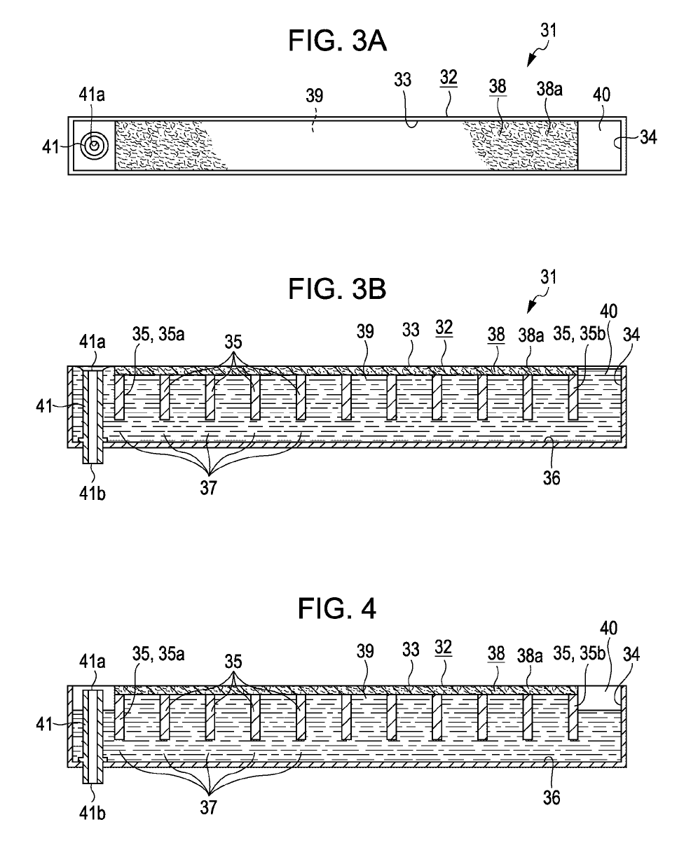

To be more specific, upper end edges of the longitudinal ribs 35 are located at slightly lower positions (for example, approximately 2 mm lower position) of the opening 33 of the box body 32. At the same time, lower end edges of the longitudinal ribs 35 are located at upper positions by a predetermined distance (for example, approximately 7 to 8 mm) with respect to a bottom surface 36 of the storage portion 34 which is a bottom of the box body 32. Further, communication portions 37 are set between the lower end edges of the longitudinal ribs 35 and the bottom surface 36 of the storage portion 34. The communication portions 37 allow the regions in the storage portion 34 divided by the longitudinal ribs 35 to communicate with each other. Thus, stored liquid containing water (water or mixed liquid of water and ink) in the storage portion 34 can flow through the communication portions 37. Reference numerals denote only communication portions 37 corresponding to a part of the longitudinal ribs 35, in FIG. 2B, FIG. 3B, and FIG. 4. In this case, the part of the longitudinal ribs 35 are five consecutive longitudinal ribs 35 from the left including the longitudinal rib 35a located at the leftmost side in the drawings.

As shown in FIGS. 3A and 3B, the ink absorbing member 38 as an absorbing member made of a porous material is arranged on an upper portion of the storage portion 34 in the box body 32. The ink absorbing member 38 is arranged so as to be in close contact with the upper end edges of the longitudinal ribs 35. Further, the ink absorbing member 38 absorbs and holds the ink discharged from the recording head 29 as waste ink. The thickness of the ink absorbing member 38 corresponds to the dimension of a space between the opening 33 of the box body 32 and the upper end edges of the longitudinal ribs 35. The height of the upper surface 38a of the ink absorbing member 38 is the same as that of the upper edge of the opening 33 of the box body 32 in a state where the ink absorbing member 38 is placed on the longitudinal ribs 35 in the box body 32 (that is, a state where the ink absorbing member 38 is supported so as to be in close contact with the upper end edges of the longitudinal ribs 35). Further, as shown in FIG. 3B, water is stored in the storage portion 34 of the box body 32. The ink absorbing member 38 supported on the longitudinal ribs 35 in the box body 32 is in contact with the water stored in the storage portion 34 so that moisture state of the ink absorbing member 38 is kept to a state where the ink absorbing member 38 is suppressed from being dried.

Further, regions in the storage portion 34 divided by the longitudinal ribs 35 are partitioned into a first region 39 in which the ink absorbing member 38 is arranged in a planar view and second regions 40 in which the ink absorbing member 38 is not arranged in a planar view. That is, the upper portion of the first region 39 is covered by the ink absorbing member 38 and the upper portions of the second regions 40 are not covered by the ink absorbing member 38. In the embodiment, the longitudinal rib 35a located at the front end side (leftmost side in FIG. 2B, FIG. 3B, and FIG. 4) and the longitudinal rib 35b located at the back end side (rightmost side in FIG. 2B, FIG. 3B, and FIG. 4) in the storage portion 34 among the longitudinal ribs 35 serve as partition walls. The partition walls partition the inner portion of the storage portion 34 of the box body 32 into the first region 39 and the second regions 40 at the positions as boundaries between the first region 39 and the second regions 40.

As shown in FIG. 2A to FIG. 4, a cylindrical overflow pipe 41 is provided in one second region 40 (front side in the embodiment) of both of the front and back pair of the second regions 40 in the storage portion 34 of the box body 32. The overflow pipe 41 penetrates through the bottom wall of the box body 32 and extends in the vertical direction. An intake (flow-in port) 41a of the overflow pipe 41 is opened at a lower position with respect to the upper surface 38a of the absorbing member 38 in the second region 40 of the storage portion 34. At the same time, an outlet (flow-out port) 41b is opened at a position which is lower than that of the intake 41a and is at a lower side of the bottom wall of the box body 32 (that is, outside the box body 32). As shown in FIG. 3B, the height of the liquid level of water (stored liquid) stored in the storage portion 34 is a position which is higher than the intake 41a of the overflow pipe 41 and lower than the upper surface 38a of the ink absorbing member 38 due to the surface tension of water.

Next, an action of the flushing box 31 having the above configuration is described.

During the printing, for example, when a predetermined period of time (for example, 5 to 20 seconds) has passed since the previous flushing finished, the recording head 29 moves to a flushing position (upper position of any one of the left and right flushing boxes 31) along with the movement of the carriage 27. At the flushing position, waste ink is discharged into the box body 32 of the flushing box 31 from the nozzle openings of the recording head 29. Then, the discharged ink is adhered to the upper surface 38a of the ink absorbing member 38 in a state where the ink absorbing member 38 is supported on the longitudinal ribs 35 in the box body 32 and absorbed into the ink absorbing member 38. Thereafter, the ink is dissolved in water which makes the ink absorbing member 38 be in a moisture state to increase an amount of stored liquid which is stored in the storage portion 34 of the box body 32.

During the printing, when the number of the flushing performed increases, an amount of the stored ink which is stored in the first region 39 in the storage portion 34 of the box body 32 is increased due to the waste ink discharged from the recording head 29 and absorbed by the ink absorbing member 38. Then, stored liquid for the increased amount moves to the second regions 40 from the first region 39 through the communication portions 37 so as to increase the amount of the stored liquid in the second regions 40 and makes the liquid level higher.

Then, when the height of the liquid level of the stored liquid in the second regions 40 is higher than the position of the intake 41a beyond the surface tension, the stored liquid flows into the overflow pipe 41 from the intake 41a. Then, the stored liquid flowing into the overflow pipe 41 is discharged to the outside of the box body 32 from the outlet 41b through the overflow pipe 41. Therefore, the liquid level of the stored liquid which is stored in the storage portion 34 does not become higher than the upper surface 38a of the ink absorbing member 38 (that is, not beyond the opening 33 of the box body 32). Accordingly, the stored liquid never overflows from the box body 32. In this point, the overflow pipe 41 functions as an overflow suppressing unit for suppressing the stored liquid from overflowing from the box body 32.

Further, as shown in FIG. 4, if printing is not performed for a long period of time, the stored liquid which is stored in the storage portion 34 evaporates so that the amount of the stored liquid is reduced and the height of the liquid level lowers in the second regions 40. This is because upper portions of the box body 32 are not covered by the ink absorbing member 38 and opened in the second regions 40. On the other hand, although the stored liquid absorbed in the ink absorbing member 38 evaporates in the first region 39 where the ink absorbing member 38 is arranged so as to be in close contact with the upper end edges of the longitudinal ribs 35 and an upper portion of the box body 32 is covered by the ink absorbing member 38, water as the amount of the evaporated liquid is replenished to the ink absorbing member from the storage portion 34 under the ink absorbing member 38 in the first region 39. With this configuration, the moisture state of the absorbing member is maintained and the air can be suppressed from flowing into through the absorbing member. Accordingly, the height of the liquid level does not lower in the first region 39. Further, in the upper portion of the storage portion 34 (that is, the opening 33 side which is opposite to the bottom), the first region 39 and the second regions 40 are partitioned by the longitudinal ribs 35a, 35b serving as the partition walls. Therefore, the stored liquid does not flow from the first region 39 to the second regions 40.

Therefore, until the height of the liquid level of the stored liquid which is stored in the second regions 40 lowers to the height corresponding to the lower end edges of the longitudinal ribs 35a, 35b (height of the liquid level at the predetermined threshold value), air is not flown to the second regions 40 from the first region 39 through the communication portions 37. Accordingly, the height of the liquid level in the first region 39 is not lowered and the ink absorbing member 38 keeps the contact state with water or mixed liquid of water and ink as the stored liquid. In this point, in the embodiment, the longitudinal ribs 35a, 35b as the partition walls function as the liquid level lowering suppressing units which suppress the liquid level in the first region 39 from being lowered when the liquid level of the liquid in the second regions 40 lowers.

According to the embodiment, the following effects can be obtained.

(1) Even when the liquid level of the stored liquid lowers in the second regions 40 because the stored liquid (water or mixed liquid of water and ink) evaporates from the box body 32 in the flushing box 31, until the liquid level is lowered to height corresponding to the lower end edges of the longitudinal ribs 35a, 35b partitioning the storage portion into the first region 39 and second regions 40 (height of the liquid level at a predetermined threshold value), the liquid level in the first region 39 is suppressed from lowering. Accordingly, the ink absorbing member 38 can keep the contact state with the stored liquid to suppress the air from flowing into through the ink absorbing member 38. This makes it possible to maintain excellent liquid receiving capacity for a long period of time.

(2) Upper end edges of the longitudinal ribs 35a, 35b are in close contact with the ink absorbing member 38 so as not to make the first region 39 and the second regions 40 communicate with each other at the upper portion in the storage portion 34. Therefore, if the ink absorbing member 38 is arranged so as to be in close contact with the upper end edges of the longitudinal ribs 35a, 35b in the storage portion 34, the ink absorbing member 38 can be made to be in contact with the stored liquid which is stored in the first region 39 in the storage portion 34. Therefore, the air can be suppressed from flowing into through the ink absorbing member 38.

(3) The first region 39 and the second regions 40 communicate with each other at the lower portion in the storage portion 34 through the communication portions 37 between the longitudinal ribs 35a, 35b and the bottom surface 36 of the storage portion 34. Therefore, the stored liquid which is stored in the storage portion 34 can be made to flow between the first region 39 and the second regions 40. Accordingly, for example, even when the stored liquid in the first region 39 increases because of increase in the number of the flushing performed, the height of the liquid level in the first region 39 can be kept to be a specified height at which the stored liquid is in contact with the absorbing member 38 by flowing the stored liquid from the first region 39 to the second regions 40.

(4) Since the overflow pipe 41 is provided in one of the second regions 40, when a total amount of waste ink discharged from the recording head 29 and received in the storage portion 34 and the water stored in the storage portion 34 (that is, total amount of mixed liquid of water and ink) increases, liquid such as water having increased in such a manner can be discharged to the outside of the box body 32. Therefore, the stored liquid can be suppressed from overflowing from the box body 32.

(5) The position of the opening of the intake 41a in the overflow pipe 41 is provided so as to be lower than that of the upper surface 38a of the ink absorbing member 38. Therefore, the liquid level of the stored liquid stored in the storage portion 34 does not become higher than the upper surface 38a of the ink absorbing member 38. Therefore, the stored liquid can be reliably suppressed from overflowing from the box body 32 beyond the opening 33.

It is to be noted that the above embodiment may be modified to be another embodiment as follows.

In the embodiment, a lid which can be freely opened and closed may be provided on the opening 33 of the box body 32 in order to suppress the stored liquid stored in the storage portion 34 from being evaporated and the opening 33 may be closed by the lid when the flushing is not performed.

In the embodiment, as the second liquid having a function of suppressing the first liquid (ink) discharged from the recording head 29 as the waste liquid from precipitation, liquid other than water may be used. For example, liquid (functional liquid) having the same component as a solvent or dispersion solvent of ink, mixed liquid of liquid other than ink and water, or mixed liquid of liquid other than ink and functional liquid may be used.

In the embodiment, an overflow suppressing unit other than the overflow pipe 41 may be used. For example, a discharge hole for discharging the overflowing stored liquid to the outside of the box body 32 may be provided on the upper portion of the side wall of the second regions 40 in the box body 32.

In the embodiment, the overflow suppressing unit such as the overflow pipe 41 may not be necessarily provided in the second regions 40.

In the embodiment, any number of the longitudinal ribs 35 may be provided in the storage portion 34. Further, the longitudinal ribs 35 may have a shape other than that in the above longitudinal ribs 35. For example, an annular wall body of which side walls are formed into a rectangular annular shape may be arranged in the box body 32, and the ink absorbing member 38 may be supported on an opening edge portion at an upper end of the annular wall body in a close contact state. Note that in this case, a through-hole serving as a communication portion is desirably formed on the annular wall body.

In the embodiment, the length of the longitudinal ribs 35 in the lengthwise direction may be length so as to be in contact with the bottom surface 36 of the storage portion 34. In this case, the communication portions 37 are desirably formed of through-holes penetrating through portions near the lower ends of the longitudinal ribs 35 or a cutout formed on the lower end edges of the longitudinal ribs 35.

In the embodiment, a discharge port for discharging the stored liquid to the outside may be provided so as to be opened on the bottom surface 36 of the storage portion 34. In this case, a valve capable of opening and closing the discharge port is prepared and the discharge port is usually in the closed state by with the valve being in the closed state. Liquid can be stored in the storage portion 34 by closing the valve. However, when the box body 32 is continuously used, components contained in the ink are deposited in a portion where liquid flow stagnation is caused on the bottom surface 36 of the storage portion 34. Even in such a case, the deposition in the stagnated portion can be discharged by periodically opening the valve to discharge the stored liquid.

In the above embodiment, although the liquid ejecting apparatus is embodied as the ink jet printer 11, a liquid ejecting apparatus which ejects or discharges liquid other than ink may be employed. The invention can be applied to various types of liquid ejecting apparatuses including a liquid ejecting head or the like which discharges a minute amount of liquid droplets. Note that the terminology liquid droplet represents the state of liquid which is discharged from the above liquid ejecting apparatus. For example, a granule form, a teardrop form, and a form that pulls a tail in a string-like form therebehind are included in the liquid droplet. The terminology liquid here represents material which can be ejected by the liquid ejecting apparatus. Any material can be used as long as it is in its liquid phase. For example, liquids having high viscosity or low viscosity, sol, gel water, other inorganic solvents, organic solvents, liquid solutions, liquid resins and fluid states such as liquid metals (metallic melts) can be used. Further, in addition to liquids as one state of a material, solutions such as a solvent can be used in which particles of a functional material made of solid material such as pigment or metal particles are dissolved, dispersed, or mixed. Typical examples of the liquid are ink described in the above embodiment and liquid crystal. The terminology ink here encompasses generic aqueous ink and oil-based ink, and various liquid composition materials such as gel ink and hot-melt ink. Specific examples of the liquid ejecting apparatuses include a liquid ejecting apparatus which ejects liquid in a form of dispersion or dissolution such as an electrode material and a coloring material. The materials such as the electrode material and the coloring material are used for manufacturing liquid crystal displays, electroluminescence (EL) displays, surface emission displays and color filters, for example. Further, the specific examples of the liquid ejecting apparatuses include a liquid ejecting apparatus which ejects bioorganic material used for manufacturing biochips, a liquid ejecting apparatus which ejects liquid used as a sample for a precision pipette, a dying apparatus and a micro-dispenser. Other examples of the liquid ejecting apparatuses include a liquid ejecting apparatus which ejects a lubricant in a pinpoint manner to a precision machine such as a watch or a camera. Further, a liquid ejecting apparatus which ejects a transparent resin liquid of an ultraviolet curable resin or the like onto a substrate in order to form a miniature hemispherical micro-lens (optical lens) used for an optical communication element is cited as an example. Also cite is a liquid ejecting apparatus which ejects an acid or alkali etching liquid for etching a substrate or the like. The invention can be applied to any type of these ejecting apparatuses.

What is claimed is:

1. A liquid receiving apparatus comprising:
a liquid receiving member which has a bottom and is capable of receiving first liquid discharged from a liquid ejecting head and storing second liquid having a function of suppressing the first liquid from being precipitated and of which upper portion is opened;
an absorbing member which is arranged in the liquid receiving member so as to be in contact with stored liquid containing the second liquid stored in the liquid receiving member and is capable of absorbing the stored liquid stored in the liquid receiving member and the first liquid discharged from the liquid ejecting head; and
a liquid level lowering suppressing unit which partitions the liquid receiving member into a first region in which an upper portion is covered by the absorbing member and second regions in which upper portions are not covered by the absorbing member and suppresses the liquid level in the first region from lowering until the liquid level of the stored liquid in the second regions lowers to height of a predetermined threshold value when the liquid level of the stored liquid is lowered.

2. The liquid receiving apparatus according to claim 1,
wherein the liquid level lowering suppressing unit includes partition walls of which upper end edges are made to be in close contact with the absorbing member at boundaries between the first region and the second regions and which are provided so as to make the first region and the second regions be in a partitioned state, and communication portions which are provided so as to make the first region and the second regions communicate with each other at the bottom side in the liquid receiving member.

3. The liquid receiving apparatus according to claim 1,
further includes an overflow suppressing unit which suppresses the stored liquid which is stored in the liquid receiving member from overflowing to the outside of the liquid receiving member in the second region.

4. The liquid receiving apparatus according to claim 3,
wherein the overflow suppressing unit is formed of an overflow pipe which is provided such that a flow-in port is opened to the second region in the liquid receiving member and a flow-out port is provided at a lower position with respect to the flow-in port and opened to the outside of the liquid receiving member, and
the flow-in port is provided at a lower position with respect to an upper surface of the absorbing member arranged in the liquid receiving member.

5. A liquid ejecting apparatus comprising:
a liquid ejecting head which ejects liquid; and
a liquid receiving apparatus which receives the liquid discharged from the liquid ejecting head as waste liquid, the liquid receiving apparatus including:
a liquid receiving member which has a bottom and is capable of receiving first liquid discharged from the liquid ejecting head and storing second liquid having a function of suppressing the first liquid from being precipitated and of which upper portion is opened;
an absorbing member which is arranged in the liquid receiving member so as to be in contact with stored liquid containing the second liquid stored in the liquid receiving member and is capable of absorbing the stored liquid stored in the liquid receiving member and the first liquid discharged from the liquid ejecting head; and
a liquid level lowering suppressing unit which partitions the liquid receiving member into a first region in which an upper portion is covered by the absorbing member and second regions in which upper portions are not covered by the absorbing member and suppresses the liquid level in the first region from lowering until the liquid level of the stored liquid in the second regions lowers to height of a predetermined threshold value when the liquid level of the stored liquid is lowered.

6. The liquid ejecting apparatus according to claim 5,
wherein the liquid level lowering suppressing unit includes partition walls of which upper end edges are made to be in close contact with the absorbing member at boundaries between the first region and the second regions and which are provided so as to make the first region and the second regions be in a partitioned state, and communication portions which are provided so as to make the first region and the second regions communicate with each other at the bottom side in the liquid receiving member.

7. The liquid ejecting apparatus according to claim 5,
wherein the liquid receiving apparatus further includes an overflow suppressing unit which suppresses the stored liquid which is stored in the liquid receiving member from overflowing to the outside of the liquid receiving member in the second region.

8. The liquid ejecting apparatus according to claim 7,
wherein the overflow suppressing unit is formed of an overflow pipe which is provided such that a flow-in port is opened to the second region in the liquid receiving member and a flow-out port is provided at a lower position with respect to the flow-in port and opened to the outside of the liquid receiving member, and
the flow-in port is provided at a lower position with respect to an upper surface of the absorbing member arranged in the liquid receiving member.
